(19) United States
(12) Patent Application Publication
(10) Pub. No.: US 2026/0187989 A1
(43) Pub. Date: Jul. 2, 2026

(54) OBJECT PROCESSING METHOD, APPARATUS, AND ELECTRONIC DEVICE

(71) Applicant: Lenovo (Beijing) Limited, Beijing (CN)

(72) Inventors: Xiao MA, Beijing (CN); Jin ZHANG, Beijing (CN); Yang ZHANG, Beijing (CN)

(21) Appl. No.: 19/425,754

(22) Filed: Dec. 18, 2025

(30) Foreign Application Priority Data
Dec. 31, 2024 (CN) 202411998148.9

(51) Int. Cl. G06V 10/80; G06V 10/74; G06V 10/774

(52) U.S. Cl. CPC G06V 10/806; G06V 10/761; G06V 10/774

(57) ABSTRACT

An object processing method includes processing a to-be-processed object to obtain key feature information of the to-be-processed object and initial feature information of the to-be-processed object, the initial feature information including local feature information and global feature information, performing fusion processing on the key feature information, the local feature information, and the global feature information to obtain target feature information of the to-be-processed object, the key feature information being target box information or text feature information of the to-be-processed object of different modalities, and determining an object satisfying a similarity condition with the target feature information of the to-be-processed object as a result object corresponding to the to-be-processed object, a modality of the to-be-processed object being different from a modality of the result object, and the modality including at least one of text, image, video, or audio.

### CROSS-REFERENCES TO RELATED APPLICATION

This application claims priority to Chinese Patent Application No. 202411998148.9, filed on Dec. 31, 2024, the entire content of which is incorporated herein by reference.

### FIELD OF TECHNOLOGY

The present disclosure relates to the cross-modal retrieval technology field and, more particularly, to an object processing method, an apparatus, and an electronic device.

### BACKGROUND

The retrieval technology between different types of modal information (for example, text-to-image or image-to-text) by using multimodal models is usually referred to as cross-modal retrieval. Through multimodal deep learning models, information of different modalities is mapped into a shared representation space to allow the two different types of information to be effectively compared and matched within the same space. However, the features extracted by the current multimodal models from the text and image information are limited to global features, and different types of modality information are processed in the same processing method. Thus, important detail information is easily neglected to cause the result of the cross-modal retrieval to have low accuracy, which hardly satisfies the needs of the user.

### SUMMARY

One aspect of the present disclosure provide an object processing method comprising processing a to-be-processed object to obtain key feature information and initial feature information of the to-be-processed object, the initial feature information comprising local feature information and global feature information, performing fusion processing on the key feature information, the local feature information, and the global feature information to obtain target feature information of the to-be-processed object, the key feature information being target box information or text feature information of the to-be-processed object of different modalities, and determining an object satisfying a similarity condition with the target feature information of the to-be-processed object as a result object corresponding to the to-be-processed object, a modality of the to-be-processed object being different from a modality of the result object, and the modality including at least one of text, image, video, or audio.

Another aspect of the present disclosure provides an object processing apparatus including an information output module, a target feature information acquisition module, and a result generation module. The information output module is configured to process a to-be-processed object to obtain key feature information of the to-be-processed object and initial feature information of the to-be-processed object. The initial feature information includes local feature information and global feature information. The target feature information acquisition module is configured to perform fusion processing on the key feature information, the local feature information, and the global feature information to obtain target feature information of the to-be-processed object. The key feature information is target box information or text feature information of the to-be-processed object of different modalities. The result generation module is configured to determine an object satisfying a similarity condition with the target feature information of the to-be-processed object as a result object corresponding to the to-be-processed object. A modality of the to-be-processed object is different from a modality of the result object. The modality includes at least one of text, image, video, or audio.

Another aspect of the present disclosure provides an electronic device, including one or more processors and one or more memories for storing one or more computer programs that, when executed by the one or more processors, cause the one or more processors to process a to-be-processed object to obtain key feature information of the to-be-processed object and initial feature information of the to-be-processed object, perform fusion processing on the key feature information, the local feature information, and the global feature information to obtain target feature information of the to-be-processed object, and determine an object satisfying a similarity condition with the target feature information of the to-be-processed object as a result object corresponding to the to-be-processed object. The initial feature information includes local feature information and global feature information. The key feature information is target box information or text feature information of the to-be-processed object of different modalities. A modality of the to-be-processed object is different from a modality of the result object, and the modality includes at least one of text, image, video, or audio.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic diagram of an application scenario of an object processing method, an apparatus, and an electronic device according to some embodiments of the present disclosure.

FIG. 2 is a schematic flowchart of an object processing method according to some embodiments of the present disclosure.

FIG. 3A is a schematic diagram showing a determination process of an image fine-grained fusion feature information according to some embodiments of the present disclosure.

FIG. 3B is a schematic diagram showing a determination process of a text coarse-fine-grained fusion feature information according to some embodiments of the present disclosure.

FIG. 3C is a schematic diagram showing a training process of a deep learning model according to some embodiments of the present disclosure.

FIG. 4 is a schematic block diagram of an object processing apparatus according to embodiments of the present disclosure.

FIG. 5 is a schematic block diagram of an electronic device for implementing an object processing method according to some embodiments of the present disclosure.

### DETAILED DESCRIPTION

Embodiments of the present disclosure are described with reference to the accompanying drawings. However, these descriptions are merely exemplary and are not intended to limit the scope of the present disclosure. In addition, in the following description, descriptions of well-known structures and techniques are omitted to avoid obscuring the concepts of the present disclosure.

The terms used herein are merely for the purpose of describing specific embodiments and are not intended to limit the present disclosure. The terms “include” and “comprise” indicate the presence of the stated features, steps, operations, and/or components, but do not preclude the presence or addition of one or more other features, steps, operations, or components.

All terms used herein (including technical and scientific terms) have meanings commonly understood by those skilled in the art, unless otherwise defined. It should be noted that the terms used herein should be interpreted as having meanings consistent with the context of this specification, and should not be interpreted in an idealized or overly rigid manner.

Some block diagrams and/or flowcharts are shown in the accompanying drawings. Some blocks in the block diagrams and/or flowcharts, or a combination thereof, may be implemented by computer program instructions. These computer program instructions can be provided to a processor of a general-purpose computer, special-purpose computer, or other programmable data processing apparatus, such that the instructions, when executed by the processor, cause the processor to create an apparatus for implementing the functions/operations illustrated in the block diagrams and/or flowcharts.

Therefore, the technology of the present disclosure can be implemented in the form of hardware and/or software (including firmware, microcode, etc.). In addition, the technology of the present disclosure may be in the form of a computer program product stored on a computer-readable medium containing instructions, which can be used with or combined with an instruction-execution system. In the context of the present disclosure, a computer-readable medium may be any medium capable of containing, storing, conveying, propagating, or transmitting instructions. For example, the computer-readable medium may include, but is not limited to, electrical, magnetic, optical, electromagnetic, infrared, or semiconductor systems, devices, apparatuses, or transmission media. Specific examples of computer-readable media include: magnetic storage devices such as magnetic tape or hard disks (HDD); optical storage devices such as optical discs (CD-ROM); memory such as random-access memory (RAM) or flash memory; and/or wired/wireless communication links.

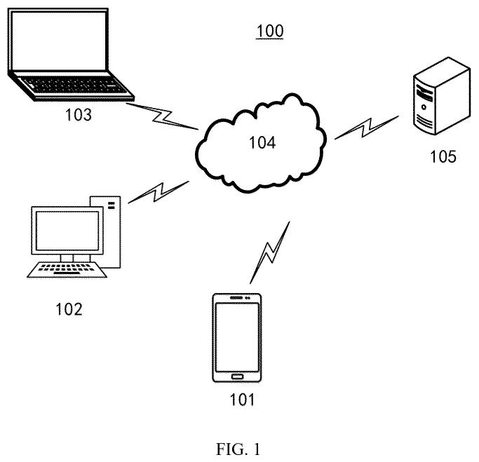

FIG. 1 is a schematic diagram of an application scenario 100 of an object processing method, an apparatus, and an electronic device according to some embodiments of the present disclosure.

FIG. 1 is merely an example of the scenario of embodiments of the present disclosure to help those skilled in the art understand the technical content of the present disclosure, and does not mean that embodiments of the present disclosure cannot be used in other devices, systems, environments, or scenarios.

As shown in FIG. 1, the application scenario 100 of embodiments of the present disclosure includes a first terminal device 101, a second terminal device 102, a third terminal device 103, a network 104, and a server 105. The network 104 is a medium configured to provide a communication link among the first terminal device 101, the second terminal device 102, the third terminal device 103, and the server 105. The network 104 can include various connection types, e.g., wired communication links, wireless communication links, or optical fiber cables.

Users can interact with the server 105 through the network 104 using the first terminal device 101, the second terminal device 102, and the third terminal device 103 to receive or send messages. Various communication-client applications can be installed on the first terminal device 101, the second terminal device 102, and the third terminal device 103.

The first terminal device 101, the second terminal device 102, and the third terminal device 103 can be various electronic devices having a display screen and supporting web browsing, including but not limited to smartphones, tablet computers, laptop computers, desktop computers, etc.

The server 105 can be a server that provides various services. For example, a to-be-processed object can be processed in the server 105 to obtain key feature information and initial feature information. For example, the key feature information, local feature information, and global feature information can be fused in the server 105 to obtain target feature information. Then, a processing result corresponding to the to-be-processed object can be determined, and the processing result (result object) can be fed back to the terminal device.

The object processing method of embodiments of the present disclosure can generally be executed by the server 105. Correspondingly, an object processing apparatus of embodiments of the present disclosure can generally be arranged in the server 105. The object processing method of embodiments of the present disclosure can also be executed by a server or a server cluster different from the server 105 and capable of communicating with the first terminal device 101, the second terminal device 102, the third terminal device 103, and/or the server 105. Correspondingly, the object processing apparatus of embodiments of the present disclosure can also be arranged in the server or server cluster different from the server 105 and capable of communicating with the first terminal device 101, the second terminal device 102, the third terminal device 103, and/or the server 105.

The number of terminal devices, networks, and servers in FIG. 1 is merely illustrative. Any number of terminal devices, networks, and servers can be provided as needed.

In some embodiments, a multimodal model (e.g., Contrastive Language-Image Pretraining, CLIP) can be applied in cross-modal retrieval tasks and can be configured to compare the image features and the corresponding text features for learning. The image feature and the text feature each can be represented by a one-dimensional vector. Paired image-text vectors can be pulled closer in space to complete tasks in image classification, text-to-image search, and image-to-text search.

However, the above method can simply include extracting a global feature for the image and text for computation. In the feature extraction process, all image blocks and text words are treated equally. Thus, the extracted features can be more suitable as the global feature, and the accuracy of the retrieval result can be low.

In some other embodiments, an attention mechanism can be added to the multimodal model architecture in an attempt to assign weights to each image block and each word in the multimodal model by introducing the attention mechanism to determine which image parts and which text parts are most important to the task.

However, for tasks similar to zero learning, the model may not receive task-specific data. Thus, the model cannot be reinforced through a large number of task-related examples to understand some tasks. Simple implicit weight learning may not be sufficient to provide enough knowledge, and the details of the image can be neglected in the extracted features. Then, the retrieval efficiency and accuracy in the text-to-image retrieval task can be lowered, and the user experience can be worsened.

Based on the above problems, the present disclosure provides an object processing method, including processing the to-be-processed object to obtain the key feature information and initial feature information of the to-be-processed object, the initial feature information including local feature information and global feature information, performing fusion processing on the key feature information, the local feature information, and the global feature information to obtain the target feature information of the to-be-processed object, the key feature information being target box information or text feature information based on the to-be-processed object of different modalities, and determining an object that satisfies a similarity condition with the target feature information of the to-be-processed object as the result object corresponding to the to-be-processed object, the modality of the to-be-processed object being different from the modality of the result object, the modality including at least one of text, image, video, or audio.

According to embodiments of the present disclosure, by performing fusion processing on the key feature information, the local feature information, and the global feature information of the to-be-processed object to obtain the target feature information that includes coarse-and fine-grained fusion. Then, the result object corresponding to the to-be-processed object can be determined. Since the target feature information is determined based on the key feature information (target box information or text feature information), by retaining the original global features, fine-grained features can be increased for the extracted target box information or text feature information to enhance the perception of the fine-grained image and text information in cross-modal retrieval. Thus, the representation ability of the overall features can be increased to further improve the user experience.

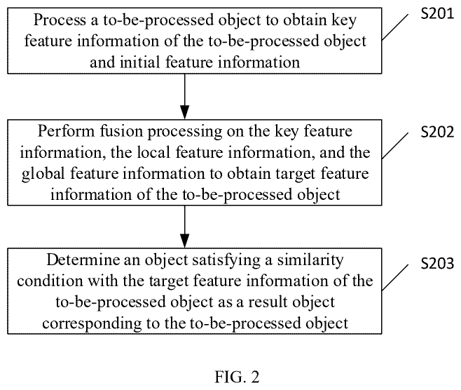

FIG. 2 is a schematic flowchart of an object processing method according to some embodiments of the present disclosure.

As shown in FIG. 2, the method includes processes S201 to S203.

At S201, the to-be-processed object is processed to obtain the key feature information and initial feature information of the to-be-processed object, the initial feature information including the local feature information and the global feature information.

In embodiments of the present disclosure, the to-be-processed object can be objects of different modalities, including but not limited to image, text, time-frequency, and audio, which can be used in scenarios such as image search engines, image annotation, visual question answering, and multimodal translation. The key feature information can include the target box information and text feature information according to the different modalities of the to-be-processed object. Thus, the key feature information can be obtained through an information detection layer in the multimodal model. The local feature information and global feature information can be obtained through an information recognition layer in the multimodal model.

For example, the image can be detected by using the information detection layer in the multimodal model to obtain the target box information of the image. The image can be recognized by using the information recognition layer in the multimodal model to extract the local feature information and the global feature information.

For example, word segmentation and retrieval processing can be performed on input text to obtain word-segmentation features and a candidate image set corresponding to the text, and the candidate images can be detected by using the information detection layer in the multimodal model to obtain text information. Then, the features from the word segmentation, same as the features of the text information can be determined as the text feature information. The text can be recognized by using the information recognition layer of the multimodal model to extract the local feature information and global feature information corresponding to the text.

At S202, the key feature information, the local feature information, and the global feature information are fused to obtain the target feature information of the to-be-processed object, the key feature information being the target box information or text feature information based on the to-be-processed object of different modalities.

In embodiments of the present disclosure, the local feature information based on the to-be-processed object of different modalities can include text local feature information or image local feature information. The global feature information based on the to-be-processed object of different modalities can include text global feature information or image global feature information. The target feature information can represent the coarse-and fine-grained feature information obtained after fusing a plurality of types of feature information, including a text coarse-fine-grained fusion feature or an image coarse-fine-grained fusion feature.

For example, the text local feature information can be weighted according to the text feature information to obtain the text fine-grained feature information. Then, the text fine-grained feature information and the text global feature information (i.e., the text coarse-fine-grained feature information) can be fused and weighted to obtain a text coarse-fine-grained fusion feature.

For example, the image local feature information can be weighted based on the image feature information to obtain the image fine-grained feature information. Then, the image fine-grained feature information and the image global feature information (i.e., the image coarse-fine-grained feature information) can be fused and weighted to obtain an image coarse-fine-grained fusion feature.

At S203, an object that satisfies a similarity condition with the target feature information of the to-be-processed object is determined as the result object corresponding to the to-be-processed object, the modality of the to-be-processed object being different from the modality of the result object, and the modality including at least one of text, image, video, or audio.

In embodiments of the present disclosure, the similarity condition can be a conditional threshold for determining the similarity between the to-be-processed object and an initial result object. Based on the comparison result with the conditional threshold, an object satisfying the conditional threshold can be selected from a plurality of initial result objects as the result object. The specific conditional threshold can be determined according to actual retrieval or recognition accuracy requirements, and is not limited herein. The modality of the to-be-processed object and the modality of the processing result can be different.

For example, an image that satisfies the conditional threshold with the text coarse-fine-grained fusion feature can be determined as the retrieval result of text-to-image retrieval. In some other embodiments, a text that satisfies the conditional threshold with the image coarse-fine-grained fusion feature can be determined as the retrieval result of image-to-text retrieval.

In some other embodiments, the modality of the to-be-processed object and the modality of the processing result can also be the same. For example, in an application scenario of retrieving a second image using a first image, the second image that satisfies the conditional threshold with the coarse-fine-grained fusion features of the first image can be determined as the retrieval result of the first image.

In embodiments of the present disclosure, the target feature information, including the coarse-fine-grained fusion feature, can be obtained by fusing the key feature information, the local feature information, and the global feature information of the to-be-processed object to determine the result object corresponding to the to-be-processed object. Since the target feature information is determined based on the key feature information (i.e., the target box information or text feature information), the fine-grained features can be added to the extracted target box information or the extracted text feature information by retaining the original global features. Thus, the perception of the fine-grained image and text information can be enhanced in the cross-modal retrieval. The representation capability of the entire feature can be improved, and the user experience can be further improved.

How to determine the result object is described above, and how to determine the target feature information is described below.

In embodiments of the present disclosure, based on the key feature information, local feature information, and global feature information, obtaining the target feature information can include processing the local feature information based on the key feature information to obtain the fine-grained feature information and performing fusion processing on the fine-grained feature information and the global feature information to obtain the target feature information.

In embodiments of the present disclosure, based on the different modalities of the to-be-processed object, the fine-grained feature information can include the text fine-grained feature or the image fine-grained feature. The fine-grained feature information can be obtained by weighing the local feature information using the key feature information. Based on the different modalities of the to-be-processed object, the target feature information can include the target text feature (i.e., the text coarse-fine-grained fusion feature) or the target image feature (i.e., the image coarse-fine-grained fusion feature). The target feature information can be obtained by further performing weighted fusion on the global feature information through the fine-grained feature information.

In embodiments of the present disclosure, the fine-grained feature information and the global feature information can include weight information of respective objects. For example, the weight information corresponding to the fine-grained feature information can be a first weight, and the weight information corresponding to the global feature information can be a second weight. Then, the weight sum of the first weight and the second weight can satisfy a target weight value. The target weight value can be a fixed value. The initial weight can represent an initial weight value of the fine-grained feature. The first weight can be obtained by updating the initial weight. The initial weight value can be determined based on actual experience or relevant experimental results.

Taking the to-be-processed object being an image as an example, after determining the key feature information (i.e., the target box information) of the image, the image local feature information (e.g., the image block) can be weighted according to the target box information to obtain the image fine-grained feature.

In embodiments of the present disclosure, the local feature information of the image can be extracted through the information recognition layer (i.e., encoding layer) of the multimodal model. For example, a to-be-processed image can be divided into a plurality of image blocks, which can be input into the encoding layer of the multimodal model (including a convolution layer and a local-response layer). Then, through the convolution layer, the features of the image blocks can be extracted. A convolution kernel can capture initial local features of the image blocks through a sliding-window operation, such as texture, edges, colors, etc. Then, the initial local feature can be abstracted in a high-level convolution through the local response layer to obtain the local feature information (e.g., a local object member, shape, or texture information).

Taking the to-be-processed object being text as an example, after determining the key feature information (i.e., the text feature information), the text local feature can be weighted using the text feature information to obtain the text fine-grained feature.

In embodiments of the present disclosure, the text local feature information can be extracted through the encoding layer of the multimodal model. For example, starting from word embeddings, the multimodal model can map words in each text into a vector space of a high-level dimension. The word vector can capture the semantic information (e.g., semantics, context, and collocation relationships). Then, further processing can be performed through an attention mechanism to allow each word to represent the embedding of the word and also be weighted and adjusted according to the context to capture richer local semantic information to obtain the text local feature.

In embodiments of the present disclosure, determining the target feature information can include updating the initial weight of the global feature information by using the first weight corresponding to the fine-grained feature information to obtain the second weight after updating the global feature information. Then, the target feature information can be obtained according to the product of the first weight and the fine-grained feature information and the product of the second weight and the global feature information. Based on the different modalities of the to-be-processed object, the target feature information can include the image coarse-fine-grained fusion feature (i.e., the image target feature information) or the text coarse-fine-grained fusion feature (i.e., the text target feature information).

The above has already described examples of how to determine the target feature information. How to determine the fine-grained feature information is described below.

In embodiments of the present disclosure, when the to-be-processed object is an image or a video, and the key feature information is the target box information, the target box information can be obtained by performing detection on the to-be-processed object. Processing the local feature information based on the key feature information to obtain the fine-grained feature information can include determining the fine-grained feature information based on the overlap image information between the local feature information and the target box information.

The target box information of embodiments of the present disclosure can represent the detection-box position information and the object-category information in the detection box obtained by the information detection layer. The target object can be detected by the information detection layer from the image, and the position of the target object in the image (i.e., the coordinate of the detection box) and the object category can be obtained. The information detection layer can also be the information detection sub-model of the multimodal model.

For example, when the to-be-processed object is input into the information detection layer, a tensor can be output representing the related information of each detection box in the image, including bounding-box coordinates, a confidence value for each detection box (i.e., indicating the probability that a target object exists in the box), and a category probability. The bounding-box coordinates can include the center coordinates (x, y) of each box, and width w and height h of the box. The category probability can indicate the probability of each category within the box.).

For example, after obtaining the image's local feature information (such as local object parts, shapes, or texture information), fine-grained feature information of the image can be obtained based on the local object shape, bounding-box coordinates, object category, and confidence value. After obtaining the fine-grained feature information of the image, the target-feature information (coarse-to-fine fused feature information of the image) can be obtained based on the fine-grained image features, local image features, and global image features.

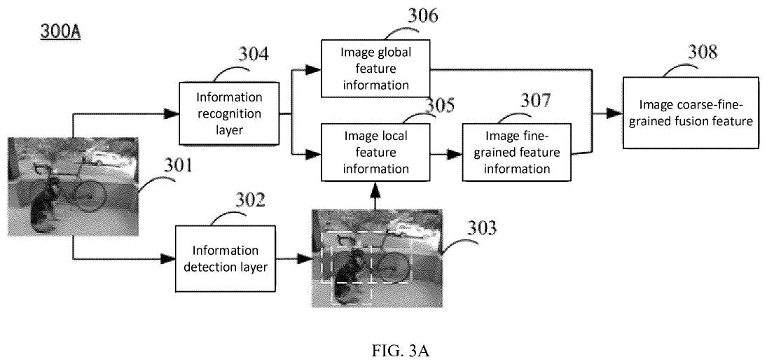

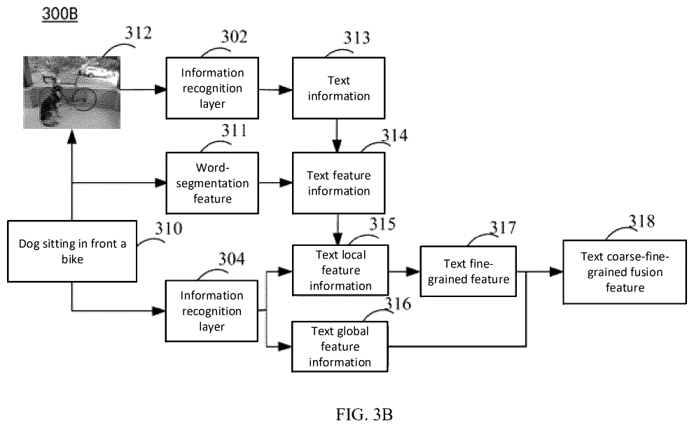

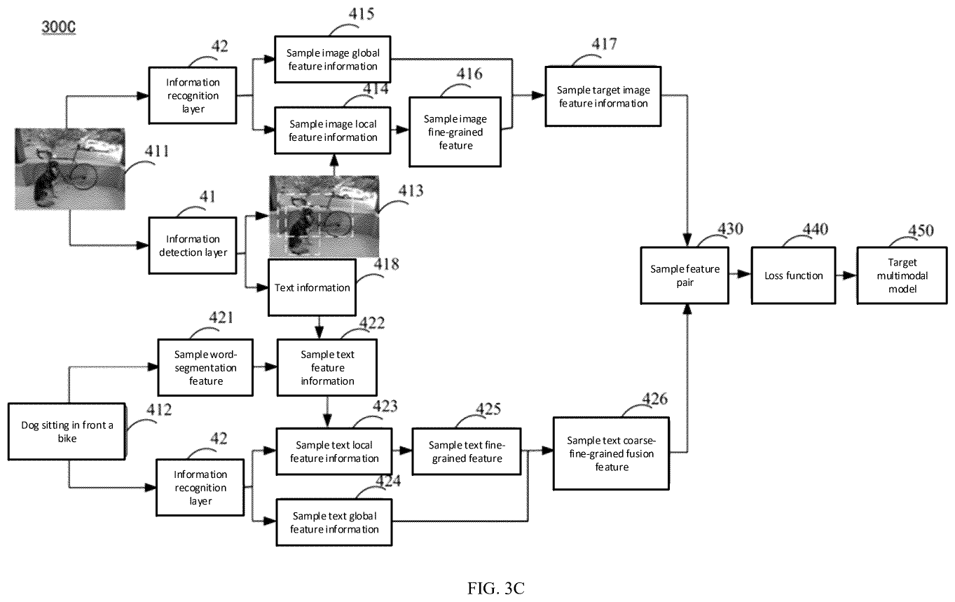

As shown in FIG. 3A, the method for determining the image fine-grained fusion feature information is described below.

FIG. 3A is a schematic diagram showing a determination process of the image fine-grained fusion feature information according to some embodiments of the present disclosure.

As shown in FIG. 3A, in 300A, the to-be-processed object is an image 301. The image 301 is detected using an information detection layer 302 in the multimodal model to obtain the target box information 303. The target box information includes the target-box coordinates and the object category in the detection box (e.g., dog, or bicycle). The image 301 can be recognized using the information-recognition layer 304 to obtain the image local feature information 305 and the image global feature information 306 corresponding to the image 301.

After obtaining the target box information 303, the image local feature information 305, and the image global feature information 306, the image local feature information 305 can be weighted using the target box information 303 to obtain the image fine-grained feature 307. Then, the image global feature information 306 and the image fine-grained feature 307 can be fused to obtain the image coarse-fine-grained fusion feature 308 (i.e., image target-feature information).

In embodiments of the present disclosure, the local feature can be processed using the target box information. The multimodal model can be configured to extract fine-grained features in the image to enhance the perception capability of the model for the image details. With the fine-grained feature, the performance of the tasks of the image classification and target detection can be improved by the fine-grained feature, thereby achieving a higher accuracy and stronger expressiveness in the multimodal fusion task.

How to determine the fine-grained feature information is described above as an example, and another example is described below on how to determine the fine-grained feature information.

In embodiments of the present disclosure, when the to-be-processed object is an audio or text, and the key-feature information is text feature information. Processing the local feature information based on the key feature information to obtain the fine-grained feature information can include determining the fine-grained feature information based on the overlap text information between the local feature information and the text feature information.

In embodiments of the present disclosure, the key-feature information corresponding to the text is text-feature information. Obtaining the text-feature information can include performing word-segmentation processing on the text to obtain word-segmentation features and searching the text. Then, detection can be performed on images in the candidate image set using the information detection layer to obtain the text information corresponding to the text. Based on this, intersection processing can be performed on the text information and the word-segmentation features to determine the overlapped text information. If the weight of the word is increased in the intersection, the text feature information can be obtained. The text information corresponding to the text can be classification information corresponding to the object in the image obtained by the image detection. After the text feature information is determined, the text feature information and the text local feature can be weighted and fused to obtain the text coarse-fine grained fusion feature information.

Below, with reference to FIG. 3B, the method for determining the text coarse-fine grained fusion feature information is further described in connection with specific embodiments of the present disclosure.

FIG. 3B is a schematic diagram showing a determination process of the text coarse-grained fusion feature information according to some embodiments of the present disclosure.

As shown in FIG. 3B, in 300B, the to-be-processed object is text 310. Word-segmentation processing is performed on the text 310 to obtain a word-segmentation feature 311, and search is performed on the text 310 to obtain a candidate image set (i.e., an image library). Then, the information detection layer 302 is configured to detect the candidate images 312 in the candidate-image set to obtain the text information 313 corresponding to the text 310. Based on this, the text information 313 and the word-segmentation feature 311 are intersected (overlapped) to obtain the text-feature information 314.

The information-recognition layer 304 can be configured to recognize the text 310 to obtain the text-local feature information 315 and the text global feature information 316 corresponding to the text 310.

After obtaining the text-feature information 314, the text-local feature information 315, and the text global feature information 316, the text-local feature information 315 can be weighted using the text-feature information 314 to obtain the text fine-grained feature 317. Then, the text global feature information 316 and the text fine-grained feature 317 can be fused to obtain the text coarse-fine-grained fusion feature (i.e., the text target feature information) 318.

In embodiments of the present disclosure, through the overlapped text information between the local feature information and the text feature information, the key semantic information can be captured to allow the model to more accurately understand the relationships between different text portions to better process the complicated text task. For example, in the multi-topic text classification, through the combination of the local feature and the text feature information, the model can better understand and differentiate the different topics in the text. Especially, in the text of multiple topics or similar topics, the distinguishing degree of the classification can be enhanced through the fine-grained feature.

In embodiments of the present disclosure, the method can further include performing word segmentation on the audio or the text to obtain a plurality of word segmentation features, and determining the word segmentation feature from the plurality of the word segmentation features that is the same as the text information corresponding to the candidate image as the text feature information. The candidate image can be obtained based on the text or the audio search.

In embodiments of the present disclosure, according to the different classifications of the input information, the word segmentation features can be obtained in different methods. For example, when the to-be-processed object is the text, obtaining the word segmentation feature can include performing a pre-processing on the text, e.g., removing a non-relevant words (a word that appears frequently is not an important word for analysis), performing the word segmentation processing on the text by using the word segmentation tool (supporting multi-languages) to obtain the word segmentation feature. Different word segmentation requirements can be satisfied by selecting different modes (e.g., accurate mode, full mode, etc.).

When the to-be-processed object is the audio, the word segmentation feature acquisition method can include processing and recognizing the audio information in the early stage (e.g., Mel-frequency cepstral coefficients being used to extract features from the audio signals and automatic audio recognition technology) to convert the audio signal into text. The subsequent processes can be the same as the text processing processes, which are not repeated.

In embodiments of the present disclosure, the candidate image can include a plurality of candidate images obtained by performing recognition and search on the text for determining the text feature information subsequently. The acquisition method and approaches of the candidate image may not be limited here.

For example, when a text search is provided, the search text can be encoded into the text vectors. Meanwhile, the system can select some images from a large image set or the candidate set as the candidate image set. The candidate image set can be filtered through the previous calculation or a simple image search method (e.g., quick filtering of metadata and label based on the image) to obtain the initial candidate image set. The image-text similarity degree between the image vector and the search text vector can be calculated for each initial candidate image. When the image-text similarity degree satisfies the pre-determined threshold, the initial image having the highest similarity degree with the search text can be determined as the candidate image. After the candidate image is determined, the text information (e.g., the object classification information in the image) corresponding to the candidate image can be generated. After the text information and the word segmentation feature are determined, the text information and the word segmentation feature can be intersected. If the word segmentation is in the intersection, the feature weight of the word segmentation can be increased to obtain the text feature information.

How to determine the text feature information has been described in detail above, and how to obtain the target feature information is described below.

In embodiments of the present disclosure, the fine-grained feature information can include a fine-grained feature and a first weight corresponding to the fine-grained feature. Fusing the fine-grained feature information and the global feature information to obtain the target feature information can include updating the initial weight of the global feature information based on the first weight to obtain the second weight corresponding to the global feature information, the sum of the first weight and the second weight satisfying the target weight value. The fine-grained feature and the global feature information can be weighted and fused based on the first weight and the second weight to determine the target feature information.

In embodiments of the present disclosure, by updating the initial weight of the global feature information, the second weight corresponding to the global feature information can be obtained. The weight corresponding to the fine-grained feature can be the first weight. The target weight value can be the sum (e.g., a fixed value) of the first weight and the second weight. The multiplication result of the first weight and the fine-grained feature can be calculated, and the multiplication result of the second weight and the global feature information can be calculated. Based on this, the target feature information can be determined.

For example, the initial weight corresponding to the global feature information can be α, and the weight corresponding to the fine-grained feature can be the first weight, denoted β. Values of α and β can be determined based on experiments or experience. Based on the first weight β and the target weight value, the initial weight α can be updated to obtain the updated second weight value α′, and the updated α′ satisfies α′+β=1. Based on this, the fine-grained features (denoted F_{local}) are weighted using β, and the global feature information (denoted F_{global}) can be weighted using the second weight α′ to obtain the target-feature information, i.e., the target-feature information=β*F_{local}+α′*F_{global}.

In embodiments of the present disclosure, by fusing the fine-grained feature and the global feature information, local details and global structures of the to-be-processed object can be better captured. The fine-grained features can focus on the local details of the to-be-processed object (e.g., local shape, texture, etc.), while the global features can focus on the overall structure of the to-be-processed object. The combination of the two can help accurately identify the result object in situations of complex backgrounds or multiple targets.

Examples of how to determine the target feature information have been further described above, and a training process of a deep learning model adopted by an object processing method is further described below.

In embodiments of the present disclosure, the object processing method can be executed through the deep-learning model, which includes an information detection layer and an information recognition layer. The training process of the deep-learning model can include inputting a first sample to-be-processed object to the information detection layer of the deep-learning model to obtain a sample target information, inputting the first sample to-be-processed object and a second sample to-be-processed object to the information recognition layer to obtain the first sample local feature information, the first sample global feature information and the second sample local feature information, and the second sample global feature information. The modality of the first sample to-be-processed object can be different from the modality of the second sample to-be-processed object.

In embodiments of the present disclosure, the deep-learning model can be a cross-modal retrieval model, such as a Contrastive Language-Image Pretraining (CLIP) model. The information detection layer can be configured to a first network layer configured to perform detection on a sample image or an image frame of a sample video to obtain the key feature information. The information recognition layer can be configured to characterize a second network layer configured to perform feature extraction on the to-be-processed object of the sample to recognize the initial feature information.

In embodiments of the present disclosure, the information detection layer can be configured to perform detection on the first sample to-be-processed object (e.g., a sample image or sample video frame) to obtain a sample target box information, including a detection box (target box) coordinate, a confidence score, and a classification probability. The information recognition layer can be configured to perform feature extraction on the first sample to-be-processed object to obtain the first sample local feature information and the first sample global feature information. The information recognition layer can be configured to perform feature extraction on the second sample to-be-processed object (e.g., a sample text or a sample audio) to obtain the second sample local feature information and the second sample global feature information.

In embodiments of the present disclosure, the deep-learning model can be trained using a loss function determined through the following operations, including determining, based on the sample target box information, the first-sample key-feature information and the second-sample key-feature information corresponding to the first-sample to-be-processed object and the second-sample to-be-processed object, respectively, determining the sample target image feature information and the sample target text feature information based on the first sample key feature information, the second sample key feature information, the first sample local feature information, the first sample global feature information, the second sample local feature information, and the second sample global feature information to obtain sample-feature pairs, and determining the loss function based on the similarity between the sample feature pairs and the label similarity. The label similarity can be obtained at least based on the original similarity between the first sample to-be-processed object and the second sample to-be-processed object.

The sample local feature information can include the first sample local feature information and the second sample local feature information. The sample global feature information can include the first sample global feature information and the second sample global feature information. The first sample and the second sample can only be used to distinguish to-be-processed objects. The specific represented object is not limited herein.

In embodiments of the present disclosure, the loss function can be used to measure a matching degree between samples of different modalities in the multi-modal model. The label similarity can be determined based on the original similarity between different sample to-be-processed objects. For example, the label similarity can be (0, 1), where 0 represents the lowest matching degree or similarity between the samples of different modalities, and 1 represents the highest matching degree or similarity between the samples of different modalities.

Taking the first sample to-be-processed object as a sample image and the second sample to-be-processed object as sample text as an example, the first sample key feature information can be the sample target box information corresponding to the sample image, and the second sample key feature information can be the sample text feature information corresponding to the sample text. Thus, the sample target image feature information can be determined based on the sample target box information, the sample image local feature information, and the sample image global feature information. Based on this, the sample feature pair can be constructed using the sample target image feature information and the sample target text feature information. Then, the similarity between the sample feature pairs can be calculated using the similarity calculation strategy (e.g., cosine similarity), and the similarity value can be converted into a probability value. The probability value can reflect the possibility of whether the sample image matches the sample text. For example, the Sigmoid function can be used to convert the similarity into the probability and marked as p. Then, a difference between the predicted probability (p) and the label similarity (0 or 1) can be calculated using a cross-entropy strategy to obtain the loss function by minimizing the error.

In embodiments of the present disclosure, the sample target box information can characterize the sample detection-box position information corresponding to the first sample to-be-processed object and the second sample to-be-processed object, and the sample object classification information in the sample detection box.

FIG. 3C is a schematic diagram showing a training process of a deep learning model according to some embodiments of the present disclosure.

As shown in FIG. 3C, in 300C, the first sample to-be-processed object is a sample image 411, and the second sample to-be-processed object is sample text 412. An information detection layer 41 in the initial multi-modal model is used to perform detection on the sample image 411 to obtain sample target box information 413 and text information 418 corresponding to the object in the target box. The sample target box information 413 can include the sample target box coordinates and the object classification information in the sample detection box. An information recognition layer 42 in the initial multi-modal model is used to recognize the sample image 411 to obtain sample image local feature information 414 and sample image global feature information 415 corresponding to the sample image 411.

After obtaining the sample target box information 413, the sample image local feature information 414, and the sample image global feature information 415, the sample image local feature information 414 can be weighted using the sample target box information 413 to obtain the sample image fine-grained feature 416. Then, the sample image global feature information 415 and the sample image fine-grained feature 416 can be fused to obtain the sample target image feature information (i.e., the sample image coarse-fine-grained fusion feature) 417.

The word-segmentation processing can be performed on the sample text 412 to obtain sample word-segmentation features 421. The sample word-segmentation features 421 can intersect with the text information 418 to obtain the overlapped text information. If the sample word-segmentation feature is in the overlapped text information, the weight of the sample word-segmentation feature can be enlarged as the sample text feature information 422. The sample text 412 can be recognized using the information recognition layer 42 to obtain sample text local feature information 423 and the sample text global feature information 424 corresponding to the sample text 412.

After obtaining the sample text feature information 422, the sample text local feature information 423, and the sample text global feature information 424, the sample text local feature information 423 can be weighted using the sample text feature information 422 to obtain the sample text fine-grained feature 425. Then, the sample text global feature information 424 and the sample text fine-grained feature 425 can be fused to obtain the sample text target-feature information (i.e., the sample text coarse-fine-grained fusion feature information) 426.

After obtaining the sample target image feature information 417 and the sample text target feature information 426, sample feature pairs 430 can be obtained. Then, the loss function 440 can be determined based on the similarity between the sample feature pairs 430 and the label similarity, and a trained target multi-modal model 450 can be obtained.

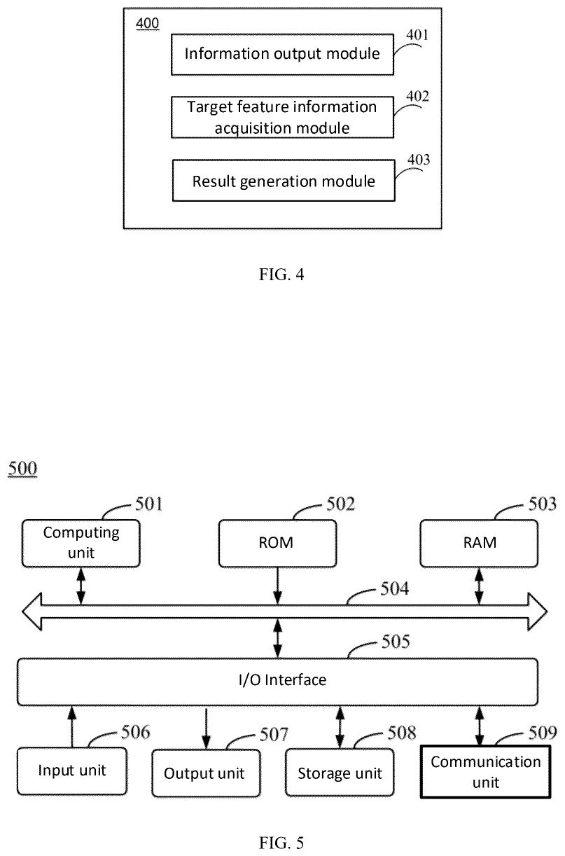

Based on the above object-processing method, the present disclosure also provides an object processing apparatus. The apparatus is described in detail below in connection with FIG. 4.

FIG. 4 is a schematic block diagram of the object processing apparatus 400 according to embodiments of the present disclosure.

As shown in FIG. 4, the object processing apparatus 400 includes an information output module 401, a target-feature-information acquisition module 402, and a result-generation module 403.

In embodiments of the present disclosure, the object processing apparatus 400 can be configured to implement the object processing method of embodiments of the present disclosure.

The information output module 401 can perform, for example, operation S201, used to process the to-be-processed object, obtaining key feature information and initial feature information of the to-be-processed object, the initial feature information including local feature information and global feature information.

The target-feature-information acquisition module 402 can be configured to perform, for example, operation S202, to fuse the key feature information, the local feature information, and the global feature information to obtain the target feature information of the to-be-processed object. The key feature information can be the target box information or text feature information based on the to-be-processed object of different modalities.

The result-generation module 403 can be configured to perform, for example, operation S203, to determine an object satisfying the similarity condition with the target feature information of the to-be-processed object as the result object corresponding to the to-be-processed object. The modality of the to-be-processed object can be different from the modality of the result object. The modality can include at least one of text, image, video, or audio.

In embodiments of the present disclosure, based on the information output module 401, the target-feature-information acquisition module 402, and the result-generation module 403 of the object processing apparatus 400, by fusing the key feature information, the local feature information, and the global feature information of the to-be-processed object, the target feature information containing the coarse-fine-grained fusion information can be obtained. Then, the result object corresponding to the to-be-processed object can be determined. Since the target feature information is determined based on the key feature information (i.e., the target box information or the text feature information), by retaining the original global features, the fine-grained feature can be added for the extracted target box information or the text feature information, and the perception for the fine-grained image and text information can be enhanced in the cross-modal retrieval to improve the overall feature characterization capability to further improve the user experience.

The information output module 401, the target feature information acquisition module 402, and the result generation module 403 can be combined in a module, or any one of the information output module 401, the target feature information acquisition module 402, and the result generation module 403 can be divided into a plurality of modules. In some other embodiments, at least some functions of one or more modules of the information output module 401, the target feature information acquisition module 402, and the result generation module 403 can be combined with at least some functions of another module, and the combination can be realized in one module. In embodiments of the present disclosure, at least one of the information output module 401, the target feature information acquisition module 402, or the result generation module 403 can be implemented at least as a hardware circuit, e.g., a field-programmable gate array (FPGA), programmable logic array (PLA), system-on-chip, system-in-package, application-specific integrated circuit (ASIC), or any other reasonable hardware or firmware for integrating or packaging circuits, or implemented in an appropriate combination of software, hardware, and firmware. In some other embodiments, at least one of the information output module 401, the target feature information acquisition module 402, or the result generation module 403 can be at least partially implemented as a computer program module that, when executed by a computer, causes the computer to perform the functions of the corresponding module.

In embodiments of the present disclosure, the target-feature-information acquisition module 402 can include a local feature-information processing submodule and a fusion-processing submodule. The local feature information processing submodule can be configured to process the local feature information based on the key feature information to obtain the fine-grained feature information. The fusion-processing submodule can be configured to fuse the fine-grained feature information and the global feature information to obtain the target feature information.

In embodiments of the present disclosure, when the to-be-processed object is an image or video, the key feature information can be the target box information. The target box information can be obtained by performing detection on the to-be-processed object. The local feature information processing submodule can include a fine-grained-feature-information determination unit, configured to determine the fine-grained feature information based on the overlapped image information between the local feature information and the target box information.

In embodiments of the present disclosure, when the to-be-processed object is voice or text, the key feature information can be the text feature information. The local feature-information processing submodule can include the fine-grained-feature-information determination unit, configured to determine the fine-grained feature information based on the overlapped text information between the local feature information and the text feature information.

In embodiments of the present disclosure, the apparatus can further include a word-segmentation processing module and a text-feature-information determination module. The word-segmentation processing module can be configured to perform word-segmentation processing on voice or text to obtain a plurality of word-segmentation features. The text-feature-information determination module can be configured to determine, from the plurality of word-segmentation features, the word-segmentation feature that is the same as the text information corresponding to the candidate image as the text feature information. The candidate image can be obtained based on text or voice retrieval.

In embodiments of the present disclosure, the fine-grained feature information can include the fine-grained features and the first weight corresponding to the fine-grained features. The fusion-processing submodule can include a second-weight acquisition unit and a target-feature-information determination unit. The second-weight acquisition unit can be configured to update the initial weight of the global feature information based on the first weight to obtain the second weight corresponding to the global feature information. The sum of the first weight and the second weight can satisfy a target weight value. The target-feature-information determination unit can be configured to determine the target feature information by fusing the fine-grained features and the global feature information based on the first weight and the second weight.

In embodiments of the present disclosure, the object-processing method can be executed by a deep learning model. The deep learning model can include an information detection layer and an information recognition layer. The training process of the deep learning model can include inputting the first sample to-be-processed object into the information detection layer of the deep learning model to obtain the sample target box information, and inputting the first sample to-be-processed object and the second sample to-be-processed object into the information recognition layer to obtain the first-sample local feature information, the first-sample global feature information and the second-sample local feature information, and second sample global feature information. The modality of the first sample to-be-processed object can be different from the modality of the second sample to-be-processed object.

In embodiments of the present disclosure, the deep learning model can be trained by the loss function determined through the following operations, including determining, based on the sample target box information, the first-sample key feature information and second-sample key feature information corresponding to the first sample to-be-processed object and the second sample to-be-processed object, respectively, determining the sample target image feature information and the sample target text feature information based on the first sample key feature information, the second sample key feature information, the first sample local feature information, the first sample global feature information, the second sample local feature information, and the second sample global feature information, to obtain the sample feature pairs, determining the loss function based on the similarity between the sample feature pairs and the label similarity. The label similarity can be obtained at least based on the original similarity between the first sample to-be-processed object and the second sample to-be-processed object.

FIG. 5 is a schematic block diagram of an electronic device for implementing the object processing method according to some embodiments of the present disclosure.

The electronic device can include various forms of digital computers, such as laptop computers, desktop computers, workstations, personal digital assistants, servers, blade servers, mainframe computers, and other suitable computers. The electronic device can also represent various forms of mobile apparatuses, such as personal digital assistants, cellular phones, smart phones, wearable devices, and other similar computing apparatuses. The components, the connections and relationships of the components, and the functions of the components of the present disclosure are merely examples and are not intended to limit the description of the present disclosure and/or the claimed implementations of the present disclosure.

As shown in FIG. 5, the device 500 includes a computing unit 501. The computing unit 501 can be configured to perform various suitable actions and processes according to the computer program stored in the read-only memory (ROM) 502 and the computer program loaded from a storage unit 508 into the random access memory (RAM) 503. Various programs and data required for the operation of the device 500 can also be stored in the RAM 503. The computing unit 501, ROM 502, and RAM 503 are connected to each other through a bus 504. An input/output (I/O) interface 505 is also connected to the bus 504.

A plurality of components in the electronic device 500 are connected to the I/O interface 505, including an input unit 506, such as a keyboard, mouse, and so on, an output unit 507, such as various types of displays, speakers, and so on, a storage unit 508, such as magnetic disks, optical disks, and so on, and a communication unit 509, such as a network card, modem, wireless communication transceiver, and so on. The communication unit 509 allows the device 500 to exchange information/data with other devices via a computer network such as the Internet and/or various telecommunication networks.

The computing unit 501 can include various general-purpose and/or special-purpose processing assemblies with processing and computing capabilities. Some examples of the computing unit 501 can include, but are not limited to, a central processing unit (CPU), a graphics processing unit (GPU), various dedicated artificial intelligence (AI) computing chips, various computing units running machine-learning model algorithms, a digital signal processor (DSP), and any appropriate processor, controller, microcontroller, and so on. The computing unit 501 can execute the various methods and processing described above, for example, the avatar-driving method. For example, in some embodiments, the avatar-driving method can be implemented as a computer software program tangibly embodied in a machine-readable medium such as the storage unit 508. In some embodiments, a part or all of the computer program can be loaded and/or installed onto the device 500 via the ROM 502 and/or the communication unit 509. When the computer program is loaded into the RAM 503 and executed by the computing unit 501, one or more steps of the avatar-driving method described above can be executed. In some other embodiments, the computing unit 501 can be configured to perform the avatar-driving method in any other appropriate manner (for example, by means of firmware).

The various embodiments of the systems and techniques described herein can be implemented in digital electronic circuit systems, integrated circuit systems, field-programmable gate arrays (FPGA), application-specific integrated circuits (ASIC), application-specific standard products (ASSP), system-on-chip (SOC), complex programmable logic devices (CPLD), computer hardware, firmware, software, and/or a combination thereof. These various embodiments can include implementations in one or more computer programs, the one or more computer programs being executable and/or interpretable on a programmable system including at least one programmable processor. The programmable processor can include a special-purpose or general-purpose programmable processor, capable of receiving data and instructions from a storage system, at least one input apparatus, and at least one output apparatus, and transmitting data and instructions to the storage system, the at least one input device, and the at least one output device.

The program code used to implement the method of the present disclosure can be written in any combination of one or more programming languages. The program code can be provided to a processor or controller of a general-purpose computer, a special-purpose computer, or other programmable data-processing apparatus. Then, the program code, when executed by the processor or controller, causes the functions/operations specified in the flowcharts and/or block diagrams to be implemented. The program code may be executed entirely on a machine, partially on a machine, partially on a machine as a standalone software package and partially on a remote machine, or entirely on a remote machine or server.

In the context of the present disclosure, the machine-readable medium can be a tangible medium that can contain or store a program for use by or in conjunction with an instruction-execution system, device, or apparatus. The machine-readable medium may be a machine-readable signal medium or a machine-readable storage medium. The machine-readable medium can include, but is not limited to, electronic, magnetic, optical, electromagnetic, infrared, or semiconductor systems, devices, or apparatuses, or any suitable combination of thereof. More specific examples of machine-readable storage media can include electrical connections having one or more wires, portable computer disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination of thereof.

To provide interaction with a user, the systems and techniques described here can be implemented on a computer. The computer can include a display apparatus (for example, a CRT (cathode ray tube) or LCD (liquid crystal display) monitor) configured to display information to the user, and a keyboard and a pointing apparatus (for example, a mouse or a trackball) through which the user can provide input to the computer. Other types of apparatuses can also be configured to provide interaction with the user. For example, feedback provided to the user can be any form of sensory feedback (e.g., visual feedback, auditory feedback, or tactile feedback). Input from the user can be received in any form (including acoustic input, speech input, or tactile input).

The systems and techniques described here can be implemented in computing systems that include back-end components (for example, as a data server), or computing systems that include middleware components (for example, an application server), or computing systems that include front-end components (for example, a user computer having a graphical user interface or a web browser, the user being able to interact with implementations of the systems and techniques described here through the graphical user interface or the web browser), or computing systems in any combination including the back-end, middleware, or front-end components. The components of the system can be interconnected through digital data communication of any form or medium (for example, a communication network). Examples of communication networks can include a local area network (LAN), a wide area network (WAN), and the Internet.

The computer system can include a client and a server. The client and the server are generally remote from each other and typically interact through a communication network. A client-server relationship can be produced by running computer programs on the corresponding computers that have such a client-server relationship with each other. The server can be a cloud server, also referred to as a cloud computing server or cloud host, which is a type of host product in a cloud computing service system to solve the defects in traditional physical hosts and VPS services (“Virtual Private Server,” or simply “VPS”), such as difficulty in management and weak business scalability. The server can also be a server in a distributed system, or a server combined with the blockchain.

Those skilled in the art can understand that the features described in various embodiments and/or in the claims of the present disclosure can be combined and/or integrated in multiple ways, even if such combinations or integrations are not explicitly described in the present disclosure. In particular, without departing from the spirit and teachings of the present disclosure, the features described in various embodiments and/or in the claims of the present disclosure can be combined and/or integrated in multiple ways. All such combinations and/or integrations shall fall within the scope of the present disclosure.

Although the present disclosure has been shown and described with reference to specific exemplary embodiments of the present disclosure, those skilled in the art should understand that various changes in form and detail can be made to the present disclosure without departing from the spirit and scope of the present disclosure as defined by the appended claims and their equivalents. Therefore, the scope of the present disclosure should not be limited to the above embodiments, but should be defined not only by the appended claims but also by the equivalents of the appended claims.

What is claimed is:

1. An object processing method comprising:
processing a to-be-processed object to obtain key feature information and initial feature information of the to-be-processed object, the initial feature information including local feature information and global feature information;
performing fusion processing on the key feature information, the local feature information, and the global feature information to obtain target feature information of the to-be-processed object, the key feature information being target box information or text feature information of the to-be-processed object of different modalities; and
determining an object satisfying a similarity condition with the target feature information of the to-be-processed object as a result object corresponding to the to-be-processed object, a modality of the to-be-processed object being different from a modality of the result object, and the modality including at least one of text, image, video, or audio.

2. The method according to claim 1, wherein obtaining the target feature information based on the key feature information, the local feature information, and the global feature information includes:
processing the local feature information based on the key feature information to obtain fine-grained feature information; and
performing fusion processing on the fine-grained feature information and the global feature information to obtain the target feature information.

3. The method according to claim 2, wherein:
when the to-be-processed object is an image or a video, the key feature information is target box information, and the target box information is obtained by detecting the to-be-processed object; and
processing the local feature information based on the key feature information to obtain fine-grained feature information includes:
determining the fine-grained feature information based on overlapped image information between the local feature information and the target box information.

4. The method according to claim 2, wherein:
when the to-be-processed object is audio or text, the key feature information is the text feature information; and
processing the local feature information based on the key feature information to obtain fine-grained feature information includes:
determining the fine-grained feature information based on overlapped text information between the local feature information and the text feature information.

5. The method according to claim 4, further comprising:
performing word-segmentation processing on the audio or the text to obtain a plurality of word-segmentation features; and
determining, from the plurality of word-segmentation features, a word-segmentation feature identical to text information corresponding to a candidate image as the text feature information, the candidate image being retrieved based on the text or the audio.

6. The method according to claim 2, wherein:
the fine-grained feature information includes a fine-grained feature and a first weight corresponding to the fine-grained feature;
performing fusion processing on the fine-grained feature information and the global feature information to obtain the target feature information includes:
updating an initial weight of the global feature information based on the first weight to obtain a second weight corresponding to the global feature information, a sum of the first weight and the second weight satisfying a target weight value; and
performing weighted fusion on the fine-grained feature and the global feature information based on the first weight and the second weight, respectively, to determine the target feature information.

7. The method according to claim 1, wherein:
the object processing method is executed by a deep learning model, the deep learning model including an information detection layer and an information recognition layer; and
a training process of the deep learning model includes:
inputting a first sample to-be-processed object into the information detection layer of the deep learning model to obtain sample target box information; and
inputting the first sample to-be-processed object and a second sample to-be-processed object into the information recognition layer to obtain first sample local feature information, first sample global feature information, second sample local feature information, and second sample global feature information, a modality of the first sample to-be-processed object being different from a modality of the second sample to-be-processed object.

8. The method according to claim 7, wherein the deep learning model is trained by a loss function, and determining the loss function includes:
determining first sample key feature information and second sample key feature information corresponding to the first sample to-be-processed object and the second sample to-be-processed object, respectively, based on the sample target box information;
determining sample target image feature information and sample target text feature information based on the first sample key feature information, the second sample key feature information, the first sample local feature information, the first sample global feature information, the second sample local feature information, and the second sample global feature information to obtain sample feature pairs; and
determining the loss function based on similarities between the sample feature pairs and label similarities, the label similarities being obtained at least based on original similarity between the first sample to-be-processed object and the second sample to-be-processed object.

9. A computer-readable storage medium storing one or more computer programs that, when executed by one or more processors, cause the one or more processors to:
process a to-be-processed object to obtain key feature information and initial feature information of the to-be-processed object, the initial feature information including local feature information and global feature information;
perform fusion processing on the key feature information, the local feature information, and the global feature information to obtain target feature information of the to-be-processed object, the key feature information being target box information or text feature information of the to-be-processed object of different modalities; and
determine an object satisfying a similarity condition with the target feature information of the to-be-processed object as a result object corresponding to the to-be-processed object, a modality of the to-be-processed object being different from a modality of the result object, and the modality including at least one of text, image, video, or audio.

10. The storage medium according to claim 9, wherein the one or more processors are further configured to:
process the local feature information based on the key feature information to obtain fine-grained feature information; and
perform fusion processing on the fine-grained feature information and the global feature information to obtain the target feature information.

11. The storage medium according to claim 10, wherein:
when the to-be-processed object is an image or a video, the key feature information is target box information, and the target box information is obtained by detecting the to-be-processed object; and
the one or more processors are further configured to determine the fine-grained feature information based on overlapped image information between the local feature information and the target box information.

12. The storage medium according to claim 10, wherein:
when the to-be-processed object is audio or text, the key feature information is the text feature information; and
the one or more processors are further configured to determine the fine-grained feature information based on overlapped text information between the local feature information and the text feature information.

13. An electronic device comprising:
one or more processors; and
one or more memories for storing one or more computer programs that, when executed by the one or more processors, cause the one or more processors to:
process a to-be-processed object to obtain key feature information and initial feature information of the to-be-processed object, the initial feature information including local feature information and global feature information;
perform fusion processing on the key feature information, the local feature information, and the global feature information to obtain target feature information of the to-be-processed object, the key feature information being target box information or text feature information of the to-be-processed object of different modalities; and
determine an object satisfying a similarity condition with the target feature information of the to-be-processed object as a result object corresponding to the to-be-processed object, a modality of the to-be-processed object being different from a modality of the result object, and the modality including at least one of text, image, video, or audio.

14. The device according to claim 13, wherein the one or more processors are further configured to:
process the local feature information based on the key feature information to obtain fine-grained feature information; and
perform fusion processing on the fine-grained feature information and the global feature information to obtain the target feature information.

15. The device according to claim 14, wherein:
when the to-be-processed object is an image or a video, the key feature information is target box information, and the target box information is obtained by detecting the to-be-processed object; and
the one or more processors are further configured to determine the fine-grained feature information based on overlapped image information between the local feature information and the target box information.

16. The device according to claim 14, wherein:
when the to-be-processed object is audio or text, the key feature information is the text feature information; and
the one or more processors are further configured to determine the fine-grained feature information based on overlapped text information between the local feature information and the text feature information.

17. The device according to claim 16, wherein the one or more processors are further configured to:
perform word-segmentation processing on the audio or the text to obtain a plurality of word-segmentation features; and
determine, from the plurality of word-segmentation features, a word-segmentation feature identical to text information corresponding to a candidate image as the text feature information, the candidate image being retrieved based on the text or the audio.

18. The device according to claim 14, wherein:
the fine-grained feature information includes a fine-grained feature and a first weight corresponding to the fine-grained feature;
the one or more processors are further configured to:
update an initial weight of the global feature information based on the first weight to obtain a second weight corresponding to the global feature information, a sum of the first weight and the second weight satisfying a target weight value; and
perform weighted fusion on the fine-grained feature and the global feature information based on the first weight and the second weight, respectively, to determine the target feature information.

19. The device according to claim 13, wherein:
the object processing method is executed by a deep learning model, the deep learning model including an information detection layer and an information recognition layer; and
a training process of the deep learning model includes:
inputting a first sample to-be-processed object into the information detection layer of the deep learning model to obtain sample target box information; and
inputting the first sample to-be-processed object and a second sample to-be-processed object into the information recognition layer to obtain first sample local feature information, first sample global feature information, second sample local feature information, and second sample global feature information, a modality of the first sample to-be-processed object being different from a modality of the second sample to-be-processed object.

20. The device according to claim 19, wherein the deep learning model is trained by a loss function, and determining the loss function includes:
determining first sample key feature information and second sample key feature information corresponding to the first sample to-be-processed object and the second sample to-be-processed object, respectively, based on the sample target box information;
determining sample target image feature information and sample target text feature information based on the first sample key feature information, the second sample key feature information, the first sample local feature information, the first sample global feature information, the second sample local feature information, and the second sample global feature information to obtain sample feature pairs; and
determining the loss function based on similarities between the sample feature pairs and label similarities, the label similarities being obtained at least based on original similarity between the first sample to-be-processed object and the second sample to-be-processed object.
